(19) United States
(12) Patent Application Publication
(10) Pub. No.: US 2020/0394680 A1
(43) Pub. Date: Dec. 17, 2020

(54) COMPUTER SYSTEM AND METHOD FOR MARKET RESEARCH AUTOMATION

(71) Applicant: Delvinia Holdings Inc., Toronto (CA)

(72) Inventors: Adam Froman, Toronto (CA); Steve Mast, Toronto (CA)

(21) Appl. No.: 16/867,040

(22) Filed: May 5, 2020

Related U.S. Application Data
(60) Provisional application No. 62/860,589, filed on Jun. 12, 2019.

(51) Int. Cl. G06Q 30/02; G06Q 10/10; G06Q 20/20

(52) U.S. Cl. CPC G06Q 30/0245; G06Q 10/10; G06Q 20/202; G06Q 30/0203; G06Q 30/0244; G06Q 30/0201

(57) ABSTRACT

A system, method and device for automated market research includes a market research automation server, a researcher computing device communicatively connected to the research automation server via a network, the researcher computing device configured to transmit the survey content data to the research automation server, and a survey respondent computing device communicatively connected to the research automation server via the network, the survey respondent computing device configured to receive the survey report from the research automation server and display the survey report. The server includes a processor configured to receive survey content data from a researcher device, generate a survey program from the survey content data, the survey program for provisioning an electronic survey, the survey program including a data collection method, receive survey response data from a respondent device, generate a survey report from the response data, and transmit the survey report to the respondent device.

### TECHNICAL FIELD

The following relates generally to research automation, and more particularly to a computer system, server, and method for automated market research.

### INTRODUCTION

Automation is a growing and emerging trend across all business sectors and verticals. Current research automation solutions in the marketplace include pure play do-it-yourself (DIY) research tools, for non-marketing users. Existing DIY research automation solutions may lack the rigor of proven research methodologies and may not connect efficiently into a consumer research panel for audience targeting.

Marketers are looking to include more customer insights earlier and more often in their research processes. This may be referred to as agile marketing, which can include quick tests throughout the process that may lead to a greater return and project success. Also, research study participants are becoming less interested in traditional long format surveys but are still interested in providing feedback more often but in shorter or more passive interactions.

These factors are changing many aspects of the market research process. For example, researchers or surveyors are requesting shorter surveys to effectivity get a ‘pulse check’ on marketing assets before going to market. As brands continue to integrate consumer insights into more parts of the marketing process, demands are increasing for new automated technologies to create cost effective and time-sensitive research.

Traditionally, market research testing such as concept testing, advertising testing, pre-concept work, idea sorting, package design testing, evaluation and in-market testing for things like recall has been conducted via long, complex research studies that can be slow and costly. As capturing data and receiving insights and results faster becomes increasingly a priority, marketing executives are searching for new methods and channels to access consumer opinions, (e.g. via social media platforms). Many of these new channels, however, lack the rigor of traditional methodologies and a profiled online research panel. Newer research approaches may include testing and analysis that provides instant feedback using AI-trained technologies.

There is a need for an online research platform that can provide a similar level of robustness as compared to custom data collection methods such as researcher-led or research consultant-led data collection methods, while also providing the ease-of-use of many current DIY solutions. Such an online research platform may increase the speed at which marketing assets are tested, analyzed and insights are reported (e.g. reduce research testing time that may normally take two weeks to as little as hours).

Clients are looking to embed the customer's voice to inform business decisions in as many aspects of their process as possible. The importance of speed and agility is key to a business' success in today's hyper connected world. Data collection methods that may help address complex research studies are needed. In some particular cases, like ad testing, there is a growing need for quick and affordable customer insights.

Accordingly, there is a need for improved systems and methods for automated market research that overcome at least some of the disadvantages of existing approaches.

### SUMMARY

A system for automated market research is provided. The system includes a market research automation server including a processor configured to receive survey content data from a researcher device and generate a survey program from the survey content data. The survey program provisions an electronic survey. The survey program includes a data collection method. The processor is further configured to receive survey response data from a respondent device, generate a survey report from the response data, and transmit the survey report to a respondent device. The system also includes a researcher computing device communicatively connected to the research automation server via a network. The researcher computing device is configured to transmit the survey content data to the research automation server. The system also includes a survey respondent computing device communicatively connected to the research automation server via the network. The survey respondent computing device is configured to receive the survey report from the research automation server and display the survey report.

The data collection method may include a concept tester method including determining how an audience may react to a researcher concept prior to launching a campaign.

The data collection method may include a finished ad tester method including validating whether a final ad is delivering an appropriate message and impact for a brand.

The data collection method may include a value proposition tester method including determining if a positioning statement resonates with a brand target market

The data collection method may include a digital experience validation method including determining how an audience will react to a certain digital experience.

The data collection method may include a user experience testing method including determining the ease with which an audience can successfully complete pre-assigned tasks.

The data collection method may include an ad tracker method including optimizing a brand's creative and media investments with in-market customer feedback and normative targets across key success benchmarks.

The data collection method may include an in-store POS method including determining if the researcher is effectively engaging customers along the path to purchase

The survey content data may include concept data. The concept data may include multimedia data and a text description. The text description may provide description for the multimedia. The multimedia data may include image data or video data.

The survey content data may include value proposition data. The value proposition data may include data for a value proposition name and text stimuli.

The survey content data may include target audience data. The target audience data may include any one or more of a survey language, an audience region, a response number, a quota control, and a demographic.

The survey content data may include question text data. The question text data may include question text for any one or more of a single answer question, a multi-answer question, a rank answers question, an open-end question, and a grid question.

The survey content data may include image data and an image as part of the survey question. The survey question may be about the image itself. The image may include an advertisement. The survey content data may include multiple images. The survey content data may include a video.

The survey content data may include answer data. The answer data may include data for answer options for a survey question.

The survey content data may include answer presentation data. The answer presentation data may inform how answer options may be presented to the respondent in the survey. The answer presentation data may include any one or more of anchoring an answer option, screening out an answer option, specifying an answer option, and randomizing answer options.

The survey content data may include logic data. The logic data may include a question where selection of a particular answer option drives the ability of the respondent to see the next question. The logic data may include a logic statement. The logic data may correspond to the logic statement.

A market research automation server for use in an automated research system is provided. The research automation server is configured to receive survey content data from a researcher device. The researcher device is communicatively connected to the research automation server via a network. The research automation server generates a survey program from the survey content data. The survey program provisions an electronic survey and includes a data collection method. The research automation server receives survey response data from a respondent device. The respondent device is communicatively connected to the research automation server via the network. The research automation server generates a survey report from the survey response data.

The survey program may include a data collection method. The data collection method may be determined according to a data collection method selection received by the research automation server.

A method of performing automated market research is provided. The method includes receiving survey content data from a researcher and generating a survey program from the survey content data. The survey program is configured to provision an electronic survey and includes a data collection method. The method further includes receiving survey response data and generating a survey report from the response data.

The survey content data may include a data collection method selection. The data collection method selection may determine the data collection method included in the survey program.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a system for research automation, according to an embodiment;

FIG. 2 is a block diagram of a computing device, according to an embodiment;

FIG. 3 is a block diagram of a system for automated market research, according to an embodiment;

FIG. 4 is a flowchart of a method of automating market research, according to an embodiment;

FIG. 5 is a graphical interface of a system for automated market research, according to an embodiment;

FIG. 6 is a graphical interface of a system for automated market research, according to an embodiment;

FIG. 7 is a graphical interface of a system for automated market research, according to an embodiment;

FIG. 8 is a graphical interface of a system for automated market research, according to an embodiment;

FIG. 9 is a graphical interface of a system for automated market research, according to an embodiment;

FIG. 10 is a graphical interface of a system for automated market research, according to an embodiment;

FIG. 11 is a graphical interface of a system for automated market research, according to an embodiment;

FIG. 12 is a graphical interface of a system for automated market research, according to an embodiment;

FIG. 13 is a graphical interface of a system for automated market research, according to an embodiment;

FIG. 14 is a graphical interface of a system for automated market research, according to an embodiment;

FIG. 15 is a graphical interface of a system for automated market research, according to an embodiment;

FIG. 16 is a graphical interface of a system for automated market research, according to an embodiment;

FIG. 17 is a graphical interface of a system for automated market research, according to an embodiment;

FIG. 18 is a graphical interface of a system for automated market research, according to an embodiment;

FIG. 19 is a graphical interface of a system for automated market research, according to an embodiment;

FIG. 20 is a graphical interface of a system for automated market research, according to an embodiment; and

FIG. 21 is a graphical interface of a system for automated market research, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/ article may be used in place of the more than one device or article.

The following relates generally to research automation, and more particularly to a computer system and method for automated market research. The systems and methods may be used to implement one or more data collection methods (or methodologies), such as a survey, in an electronic format.

The systems and methods described herein can be used to create a data collection method, preview the data collection method, deploy the data collection method and collect response data, and report results. In an embodiment, a system includes a web-based application for allowing a user, such as a researcher, to interact with a research automation platform. The web-based application may include a mobile application or voice-based surveys. In an embodiment, the system may include SDK/API access and the platform may be used without an interface or device. Automated scripts can control the platform.

Throughout the present disclosure, reference may be made to surveys, surveyors, survey questions, survey content data, survey response data, survey deployer module, and the like. It is understood that the use of the term “survey” in such contexts is merely exemplary of particular embodiments in which the data collection method employed is a survey. A survey is one example of a data collection method. The systems and methods described herein may be used with other data collection methods.

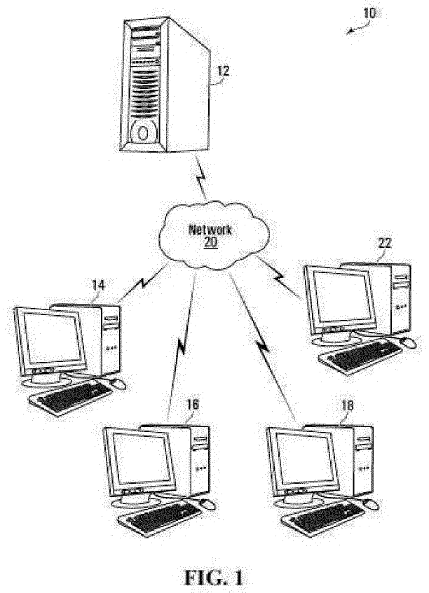

Referring now to FIG. 1, shown therein is a block diagram illustrating a system 10, according to an embodiment. The system 10 includes a research automation server platform 12, which communicates with a plurality of researcher devices 16, a plurality of respondent devices 18, and a plurality of data collection method programmer devices 22 via a network 20.

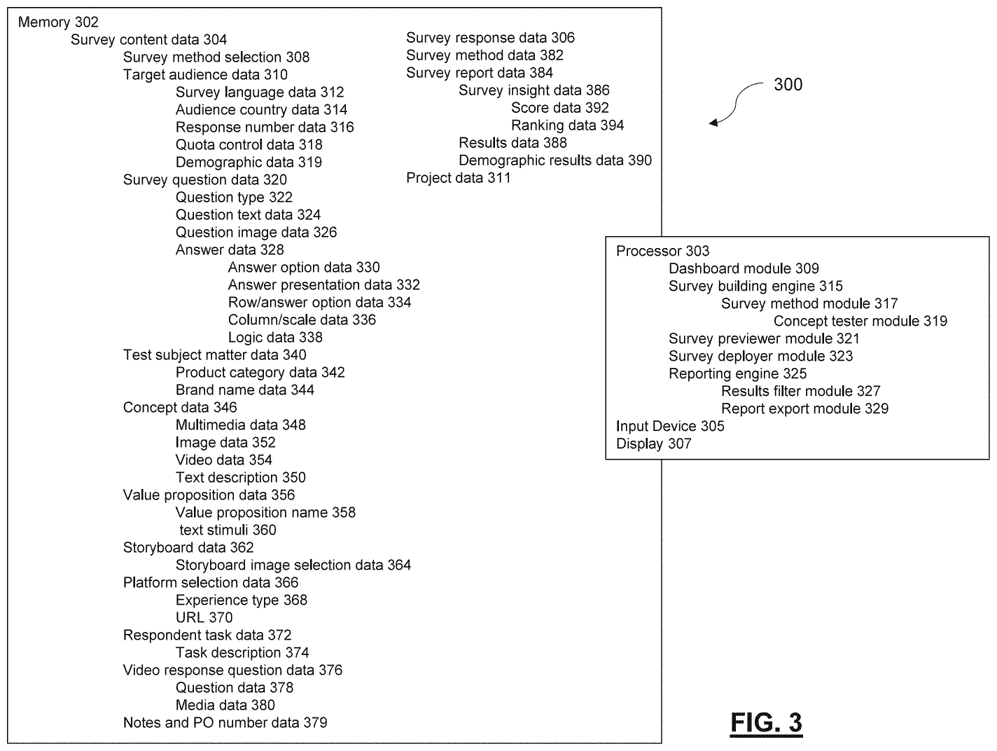

The server platform 12 may be a purpose-built machine designed specifically for providing a research automation platform (RAP). The server platform 12 may include multiple servers and tools to allow for automation. The server 12 may receive survey content/input data from the researcher device 16. The programmer device 22 may communicate with the server 12 to create an electronic survey program using the survey content data (e.g. survey content data 304 of FIG. 3). The server 12 may provision the survey program to the respondent device 18 and collect survey response data therefrom.

The survey program may be an online web-based application. The survey program may be a web-based application executing partially on the server 12 and partially on the respondent device 22. The web-based survey application may promote the respondent to interact with the survey program content (e.g. answer survey questions) using the survey respondent device 18. The survey program may be a webpage (e.g. an HTML based webpage) or a smartphone application. The web application (or webpage) may use a markup language, such as HTML.

Survey response data corresponding to selections and input provided by the respondent can be stored at server 12. The stored survey response data can be analyzed to provide results to the researcher. The researcher may use the results to draw inferences about a larger population. The survey response data may be analyzed by the server 12 and the results sent to and displayed at the researcher device 16.

The server platform 12 and devices 16, 18 and 22 may be a server computer, desktop computer, notebook computer, tablet, PDA, smartphone, or another computing device. The devices 12, 16, 18, 22 may include a connection with the network 20 such as a wired or wireless connection to the Internet. In some cases, the network 20 may include other types of computer or telecommunication networks. The devices 12, 16, 18, 22 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network 20.

Input device may include any device for entering information into device 12, 16, 18, 22. For example, input device may be a keyboard, key pad, cursor-control device, touch-screen, camera, sensors (e.g. atmospheric, biometric, neuro, etc.) or computer microphone embedded in any type of digital device (such as a smartphone, computer, or a voice assistant). Display device may include any type of device for presenting visual information. For example, display device may be a computer monitor, a flat-screen display, a projector or a display panel or a voice-enabled device. Output device may include any type of device for presenting a hard copy of information, such as a printer for example. Output device may also include other types of output devices such as speakers, for example. In some cases, device 12, 16, 18, 22 may include multiple of any one or more of processors, applications, software modules, second storage devices, network connections, input devices, output devices, and display devices.

Although devices 12, 16, 18, 22 are described with various components, one skilled in the art will appreciate that the devices 12, 16, 18, 22 may in some cases contain fewer, additional or different components. In addition, although aspects of an implementation of the devices 12, 16, 18, 22 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 16, 18, 22 and/or processor to perform a particular method.

Devices such as server platform 12 and devices 16, 18 and 22 can be described performing certain acts. It will be appreciated that any one or more of these devices may perform an act automatically or in response to an interaction by a user of that device. That is, the user of the device may manipulate one or more input devices (e.g. a touchscreen, a mouse, a button, a sensor (e.g. atmospheric, biometric, neuro)) causing the device to perform the described act. In many cases, this aspect may not be described below, but it will be understood.

As an example, it is described below that the devices 12, 16, 18, 22 may send information to the server platform 12. For example, a user using the device 18 may manipulate one or more inputs (e.g. a mouse and a keyboard) to interact with a user interface displayed on a display of the device 18. Generally, the device may receive a user interface from the network 20 (e.g. in the form of a webpage). Alternatively or in addition, a user interface may be stored locally at a device (e.g. a cache of a webpage or a mobile application).

Server platform 12 may be configured to receive a plurality of information, from each of the plurality of devices 16, 18, 22.

In response to receiving information, the server platform 12 may store the information in a storage database. The storage may correspond with secondary storage of the devices 16, 18 and 22. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

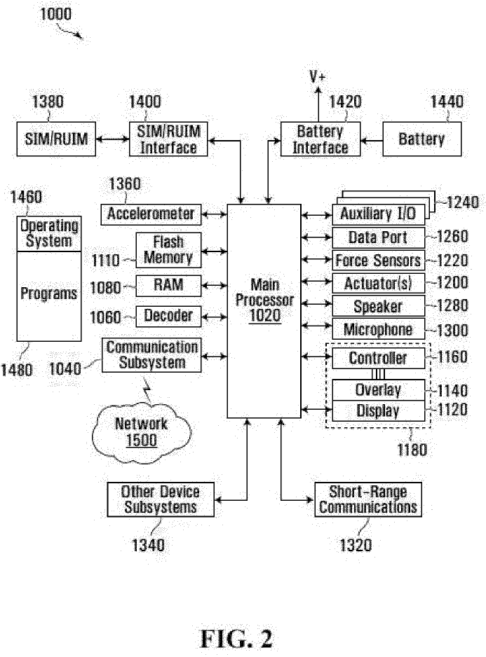

FIG. 2 shows a simplified block diagram of components of a device 1000, such as a mobile device or portable electronic device. The device 1000 includes multiple components such as a processor 1020 that controls the operations of the device 1000. Communication functions, including data communications, voice communications, or both may be performed through a communication subsystem 1040. Data received by the device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a portable electronic device generated by the processor 102 may be displayed on the touch-sensitive display 118.

The processor 1020 may also interact with an accelerometer 1360 as shown in FIG. 1. The accelerometer 1360 may be utilized for detecting direction of gravitational forces or gravity-induced reaction forces.

To identify a subscriber for network access according to the present embodiment, the device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The device 1000 also includes an operating system 1460 and software components 1480 that are executed by the processor 1020 and which may be stored in a persistent data storage device such as the flash memory 1100. Additional applications may be loaded onto the device 1000 through the wireless network 1500, the auxiliary I/O subsystem 1240, the data port 1260, the short-range communications subsystem 1320, or any other suitable device subsystem 1340.

For example, in use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the portable electronic device 1000 may be similar. The speaker 1280 may output audible information converted from electrical signals, and the microphone 1300 may convert audible information into electrical signals for processing.

Referring again to FIG. 1, the researcher device 18 is associated with a researcher (e.g. surveyor). The researcher may be an entity, such as a company or organization, that wants to collect/obtain information about the attitudes, opinions, or preferences of a population or group. The researcher may want to engage in market research. The group may be prospective customers. The researcher may not have the resources or capabilities to create and deliver an electronic survey. The researcher may want to outsource the creation and delivery of the survey and receive results.

Referring now to FIG. 3, shown therein is a computer system or computer device 300 for automated market research, according to an embodiment.

The system 300 includes a memory 302 for storing survey content data 304 and survey response data 306. The memory may be stored at any one or more of a server (e.g. server 12 of FIG. 1) ora user device (e.g. devices 16, 18, 22 of FIG. 1).

The survey content data 304 can be used to create a computer-implemented survey (or electronic survey). The survey includes a plurality of survey questions. In some cases, the survey may include images, video, interactive prototype, mobile app, website, game, or application.

The survey content data 304 includes a data collection method selection 308. The data collection method selection 308 indicates a data collection method for the survey. The data collection method selection 308 informs what information the system 300 collects from the researcher. The data collection method may have an associated objective (e.g. to test ad concepts) that a survey embodying the data collection method seeks to meet through the collection of response data 306 from respondents.

The data collection method may include any one or more of a custom survey method, a concept test method, a value proposition test method, a finished ad test method, a digital experience validation method, a user experience test method, an ad tracker method, in-store point-of-sale (“POS”) method, and a video response method.

The custom survey method (or survey builder method) allows a user to create a custom data collection method to collect response data 306 desired by the user /researcher. The custom survey method may be used to create a custom survey of a researcher's own questions.

The concept tester method may be used to determine how an audience may react to a researcher idea prior to launching a campaign.

The finished ad tester method may be used to validate whether a final ad is delivering an appropriate message for a brand.

The value proposition tester method may be used to determine if a positioning statement resonates with a target market.

The digital experience validation method may be used to determine how an audience will react to a certain digital experience (provided by the researcher).

The user experience testing method may be used to determine how an audience will use a researcher platform by completing tasks. The user experience testing method may allow a user to compare their experience against competitors.

The ad tracker method may be used to optimize a brand's creative and media investments with in-market customer feedback and normative targets across key success benchmarks.

The in-store POS method may be used to determine if the researcher is effectively engaging customers along the path to purchase.

The video response method may be used to capture and analyze video responses. The video response method uses video capturing technology (e.g. Voxpopme™). The video response method accesses a camera of the respondent device 18 to record video of the respondent's response to a survey question. The video can be automatically transcribed (for example, via a third party solution), analyzed and results aggregated with response data of other respondents. The video may be provided to a researcher, for example via researcher device 16, and the researcher may review data associated with the video via analysis of the transcription. This may include sentiment, themes, and word clouds.

The survey content data 304 includes target audience data 310. The target audience data 310 includes data for any one or more of a survey language 312, an audience region or country 314, a response number 316, a quota control (or sample type) 318, and a demographic 320.

The survey language data 312 may include a primary language and a secondary language. Multiple studies may be used for multiple languages unless the data had to be aggregated. In some cases, a user can add more than two languages. Results of multiple studies may be brought together.

The response number data 316 includes the number of respondents to complete the survey. The response number 316 may have a lower limit and an upper limit. The lower limit may be set to a statistically significant number. In an embodiment, the response number data 316 may have a range from 500 to 1000 responses.

The quota control data 318 may include a sample type. The sample type includes the type of respondents to complete the survey. The sample type may reflect a region (e.g. a country, such as Canada or the US), or a portion or segment thereof. An example sample type may be an interlocked national representation sample. The interlocked national representation sample may be a sample group that is representative of national Canada based on Statistics Canada data.

The demographic data 319 may include a specific demographic or type of respondent (person) to be targeted for the survey. The demographic data 319 may provide for advanced targeting. The demographic data 319 may include any one or more of age range, alcoholic beverages consumed, auto vehicle own, born in a designated country (e.g. Canada), citizenship, company revenue, company size, decision maker and influencer, education, employment status, household income, insurance provider—life, insurance provider medical, insurance provider travel, internet provider, investments, main bank, main credit card, marital status, medical ailments household, medical ailments self, mobile phone brand, mobile provider, multi-cultural ethnicity, number of people in household, personal travel frequency, person travel locations, pet owner, province, rent or own residence, smoke, sports attend, sports participate, sports TV, tablet ownership, telephone landline, TV provider, type of residence, value of home, and vision glasses contacts. In variations, fewer or more demographic options may be available. Demographic options may depend on country or region.

The survey content data 304 may include survey question data 320. The survey question data 320 includes data for a question type 322. The question type 322 may be a single answer question, a multi-answer question, a rank answer question, an open-end question, a grid question, or the like.

A single answer question allows a respondent to select one answer from multiple answer options. A multi-answer question allows a respondent to select multiple answers from multiple answer options. A rank answers question allows a respondent to rank answer options. An open-end answer question allows a respondent to provide a free text answer. The free-text answer may have a character limit. A grid answer question allows a respondent to select an answer option for each row on a grid. The grid includes rows/answers and columns/scales.

The survey question data 320 includes question text data 324. The question text data 324 may include question text for any one or more of a single answer question, a multi-answer question, a rank answers question, an open-end question, and a grid question. This feature may include an ability to create rich text formatting.

The survey question data 320 may include image data 326. The survey question data 320 may include image data 326 where a researcher wants to include an image as part of the survey question, such as when the question is about the image itself (for example, if the image includes an ad or the like). In some cases, the survey question data 320 may include video, audio, prototypes, live websites, or mobile applications. The audio may be presented as a blank video with audio soundtrack.

The survey question data 320 includes answer data 328. The answer data 328 includes data for the answer options 330 (e.g. text) for the survey question. A given survey question includes multiple answer options, which can be represented by text. In variations, answer options may be represented as images (which may or may have associated text labels or descriptions). The respondent can select one or more of the answers options for the question, depending on the question type. In the case of an open-end question, there is a text field or the like into which the respondent can enter an answer (and thus no answer options).

The answer data 328 may include answer presentation data 332. The answer presentation data 332 informs how answer options may be presented to the respondent in the survey. The answer presentation data 332 may include data for any one or more of anchoring an answer option, screening out an answer option, specifying an answer option, and randomizing answer options.

Anchoring an answer option keeps an answer option at its current position in the list of answer options (e.g. as it is displayed to the respondent). Screening out an answer option can allow for respondents to qualify for additional questions based on choosing a particular answer option. Specifying an answer option can allow for a respondent to provide an open-ended (i.e. free text) answer upon choosing a particular answer option or to provide further explanation as to why the particular answer option was chosen. For example, a user may select an “other” answer option and provide a free text description in an open-end text box. Randomizing answer options randomizes the order of presentation of answer options to the user (e.g. respondent).

In the case of a grid question, the answer data 328 includes row/answer option data 334 and column/scale data 336. The row/answer option data 334 includes multiple answer options. The column/scale data 336 includes data for a scale. The scale may be a predefined scale or a custom scale. The predefined scale includes predefined answer options for the scale. The predefined scale may include an appealing/unappealing scale, a likely/unlikely scale, an agree/disagree scale, a better/worse scale, or a familiar/unfamiliar scale. The custom scale includes a scale defined by the researcher (e.g. text answer options inputted by the researcher). Answer option randomization may include rows and/or columns of the grid. The answer presentation data 332 may include data for display answer options as a carousal (which can be mobile device friendly).

The answer data 328 may include logic data 338. The logic data 338 can be used to create a question where the selection of a particular answer option drives the ability of the respondent to see the next question. The logic data 338 may include a logic statement created by the user. The logic data 338 may correspond to certain portions of the logic statement (to complete the logic statement). The logic data 338 may include data indicating that a particular survey question is only shown if all of the provided rules are true, not shown if all of the provided rules are true, only shown if any of the provided rules are true, or not shown if any of the provided rules are true. The rules may include logic data including an answer option and whether the option is selected or not selected (e.g. if question 1 answer A is not selected).

The survey content data 304 may include test subject matter data 340. The test subject matter data 340 includes a product category 342 and a brand name 344. In an embodiment, the product category 342 and brand name 344 are variables placed into a data collection method template. In other embodiments, other or additional variables may be placed into the method template.

The survey content data 304 may include concept data 346. The concept data 346 includes multimedia data 348 and a text description 350. The text description 350 provides some description for the multimedia. The multimedia data 348 may be image data 352 or video data 354. The multimedia data 348 may include an interactive prototype. The interactive prototype may be an image slideshow of a web experience in wireframe, medium resolution or high-resolution mockups, or an interactive prototype with clickable areas simulating a mobile application or web experience.

The survey content data 304 may include value proposition data 356. The value proposition data 356 may include data for a value proposition name 358 and text stimuli 360.

The survey content data 304 may include storyboard data 362. The storyboard data 362 includes data for a video and a storyboard description (of the image or video). The storyboard data 362 includes storyboard image selection data 364. The video data is processed to create storyboard data 362. This may include processing video data to create thumbnails for each second of the video that subsequently used by the user to create a storyboard. The storyboard data 362 includes images from the video. The storyboard image selection data 364 includes a selection of a subset of the storyboard images that the respondent views.

The survey content data 304 may include platform selection data 366. The platform selection data 366 includes data for an experience type (to be tested) 368 and a URL 370. The experience type 368 may be a concept, prototype, live website, a mobile app, etc.

The survey content data 304 may include respondent task data 372. The respondent task data 372 includes data for a task description 374. The task description 374 may include a statement such as “find the [object]”. The task description 374 may instruct a respondent to try and find certain elements in a user interface to test a user experience.

The survey content data 304 may include video response data 376. The video response data 376 may include question data 378 and media data 380. The question data 378 may include data for a context, a question, and a prompt. The media data 380 may include a media type (e.g. image, video) and a media data (e.g. image, video). Other features may include an ability to add rich text formatting to stimuli or questions. In an embodiment, a video response may be recorded, transcribed, analyzed, accessed, and/or edited. One or more of these actions may be performed by the system 300, or by an external system including a computing device communicatively connected to the system 300. In some cases, the external system may be a third party system such as Voxpopme™. In such cases, the video response may not be directly recorded, transcribed, analyzed, accessed, or edited within the system 300. The question itself may be created in the system 300.

The survey content data 304 may include note and PO number data 379, for providing an area to insert data not visible to the respondent but visible to the researcher user.

The system 300 includes a processor 303. The processor 303 is configured to execute a plurality of software modules including computer-implemented instructions that, when executed, cause the system 300 to perform actions, operations, and functions described herein. The processor may be located at the server 12 or the user device (e.g. researcher device 16 or respondent device 18 o FIG. 1).

The system 300 includes a user input device 305 for receiving user input of survey content/input data or survey response data 306. The user input device 305 may be located at the researcher device 16 or the respondent device 18. The survey content/input and response data may be stored at memory 302.

The system 300 includes a display 307 for displaying a user interface for facilitating user interaction with the system. The display 307 may be at the researcher device 16 or respondent device 18.

The processor includes a dashboard module 309. The dashboard module 309 generates a project summary and a project list. The display 307 displays the project summary and project list. The project summary and project list include project data 311 about projects associated with a user (i.e. researcher). The project includes a survey. The project data 311 may be associated with a user account for the user. The project data 311 may include data for any one or more of a project name, a group type (e.g. demo group), a data collection method type, a status type (e.g. draft, internal review, survey programmer approval, live, closed), and a creation date.

The dashboard module 309 categorizes projects in the project summary according to status type and provides a snapshot of the number of projects for a specific status type. The display 307 displays a number of projects for each status type. The project summary includes a filter function that allows convenient filtering by status type. The dashboard module 309 may generate icons for each of the status type including a project number, a colour differentiator, and a graphic that, when displayed by the display 307, promote easy navigation and review by the user.

The dashboard module 309 generates the project list from the project data 311 for the user. The project list may include certain project data 311 for each project in the project list to make a project easily identifiable by the user.

The dashboard module 309 includes a search function. The search function generates a subset of the project list based on the search terms. The project list subset is displayed by the display 307. In an embodiment, the search function can retrieve a project and generate a project list based on a project name. The search function promotes easy navigation and identification of particular projects to reduce time a user may waste looking through a long project list for a specific project.

The dashboard module 309 includes a filter function. The filter function filters projects according to certain project data 311. For example, the filter function may filter projects according to status type. The display 307 displays the filtered results. The filter function may allow a user to conveniently access projects or view information about projects by reducing the amount of information presented for irrelevant projects.

The processor 303 includes a data collection method builder engine 315. The data collection method builder engine 315 collects survey content data 304 and generates a survey (i.e. survey program) using the survey content data 304 as input.

The data collection method builder engine 315 includes a plurality of data collection method modules. A data collection method module 317 includes computer-executable instructions for collecting survey content data 304 for the data collection method type and for generating a survey program implementing the data collection method using the survey content data 304. The data collection method may be any data collection method, of which a survey is one type.

The data collection method module 317 may be any one or more of a custom survey method module, a concept tester module, a finished ad tester module, a value proposition tester module, a digital experience validation module, a user experience testing module, an ad tracker module, an in-store POS module, and a video response module.

The data collection method builder engine 315 receives a data collection method selection 308. The data collection method builder engine 315 determines the appropriate data collection method module 317 for execution by the processor 303 using the data collection method selection 308. For example, the data collection method builder engine 315 may receive a data collection method selection 308 indicating a concept test method and determine that a concept tester module should be executed.

The data collection method module 317 collects the appropriate survey content data 304 for the data collection method type. The data collection method module 317 generates a survey program implementing the data collection method using the survey content data 304 as input. The survey program can be stored at memory 302 and used in a preview mode (e.g. using the survey previewer module 321, described below) or in a live/deployment mode (e.g. using the survey deployer module 323, described below).

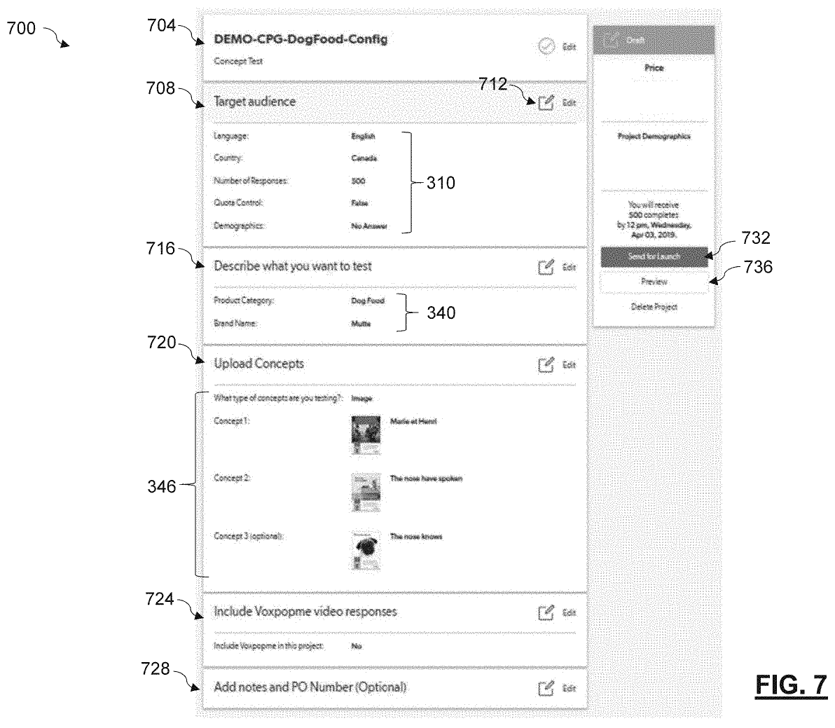

In an example, a concept tester module 319 collects survey content data 304 from a user (i.e. a researcher) for a concept test method type. The concept tester module 319 may implement a user interface (e.g. user interface 700 of FIG. 7) displayed at the display 307 for collecting the survey content data 304. The survey content data 304 includes target audience data 310, test subject matter data 340, and concept data 346. As described above, the concept data 346 may include one or more images (e.g. representing an ad concept) and one or more associated text descriptions for the images.

The concept tester module 319 generates a concept test survey using the survey content data 304 provided by the user and data collection method data 382. The data collection method data 382 (which in this example includes concept ad test method data) includes data other than survey content data 304 used to generate the data collection method. The concept test method can be viewed in a preview mode (e.g. how it will appear when deployed for respondent use). The data collection method data 382 may include a template for the data collection method. The template may comprise reusable data for the particular data collection method. In such cases, the template portion (or the data collection method including the template) may be considered a repeatable method.

The processor 303 includes a survey previewer module 321. The survey previewer module 321 generates a survey preview from the survey content data 304 and the data collection method data 382. The survey previewer module 321 may be configured to display the survey preview in a popup window or the like, for example at display 307. The survey preview allows a researcher to view and navigate the survey from the perspective of a respondent in order to determine if changes to the survey should be made. The survey previewer module 321 may receive and store response data 306 as necessary to implement the preview but may forgo longer-term storage of response data 306 (as may be done for response data 306 received from a respondent during actual deployment of the survey).

The processor 303 includes a survey deployer module 323. The survey deployer module 323 deploys the survey program generated by the data collection method builder engine 315. Deploying the survey program may include making the survey accessible to a respondent on a respondent device 18, such as via a web application or web page hosted by the server and accessible via a web browser on the respondent device 18. A project may be launched, and a data collection method may be reviewed (e.g. a survey) for quality assurance by a project manager or the like (e.g. via a survey programmer device). The data collection mechanism may be deployed through a panel partner user experience.

The survey deployer module 323 also collects survey response data 306 from respondents. The respondents may provide the survey response data 306 through interaction via a user interface at the respondent device 18. The response data 306 may be transmitted from the respondent device 18 to the server 12 for storage and/or analysis.

The processor 303 includes a reporting engine 325. The reporting engine 325 receives survey response data 306, analyzes the survey response data 306, and generates survey report data 384. The survey report data 384 may be organized and presented as a survey report at display 307. The survey report may include one or more visualization tools such as graphs, charts, tables, or the like for graphically representing survey results.

The survey report data 384 includes survey insight data 386. The survey insight data 386 may include score data 392 and ranking data 394. The score data 392 may include a score generated using a proprietary weighting matrix. The ranking data 394 may be based on the score data 392.

The survey report data 384 includes results data 388. Examples of results data include but are not limited to overall likeability data, message intrusion data, ad intrusion data, confusion data, uniqueness data, relevance data, and fits with brand data. The reporting engine 325 may be configured to generate a visualization tool (e.g. graph) for visually representing the results data 388.

The survey report data 384 includes demographic results data 390. Examples of demographic results data 390 may include but are not limited to age results data (e.g. by age range, such as 18-34), geographic results data (e.g. by province or state), regional results data (e.g. results for western Canada), and gender results.

The reporting engine 325 includes a filter module 327. The filter module 327 filters survey results according to a user-selected results subset. The results subsets may be demographic subsets. Examples of results subsets include but are not limited to age (e.g. 18-34, 35-49, 50-65), geographical region (e.g. Western Canada, Ontario, Quebec, Atlantic Canada), and gender. The filter module may advantageously allow the user to view a subset of results for a particular demographic of interest by filtering out results that are not of interest.

The reporting engine 325 includes an export module 329. The export module 329 exports the survey report data 384 to another file format. The file format may be selectable by the user from multiple file format options. For example, the export results function may be configured to export results to a pptx file, pdf file, or data file (e.g. Excel file).

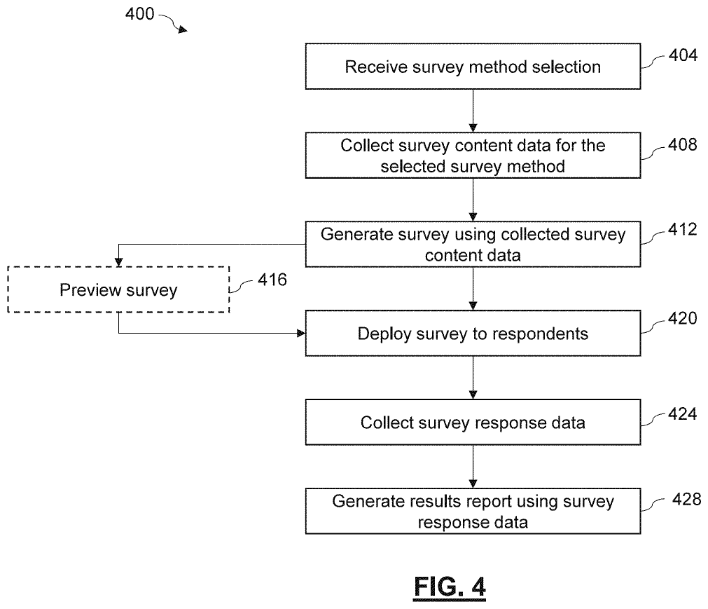

Referring now to FIG. 4, shown therein is a method 400 of automating market research, according to an embodiment. The method 400 may be implemented using the system 300 of FIG. 3. Aspects of the method may be carried out by a server (e.g. server 12 of FIG. 1) or a user device (e.g. researcher device 16, respondent device 18 of FIG. 1). The method 400 may allow a researcher to build an electronic survey, collect response data for the survey, and view results via a report.

At 404, a data collection method selection 308 is received. The data collection method selection 308 indicates a desired data collection method that a user wants to implement. The data collection method selection 308 can be provided by a user via an input device (e.g. input device 300 of FIG. 3). The data collection method selection 308 may be provided at a user device (e.g. researcher device 16 of FIG. 1), for example via a user interface displayed at the user device and transmitted to a server (e.g. server 12 of FIG. 1).

At 408, survey content data 304 for the selected data collection method is collected. The type of survey content data 304 collected is determined by the data collection method selection 308. For example, each data collection method may include specific survey content data 304 for that method type that is to be collected. The collected survey content data 304 is used to build a survey implementing the data collection method. A user interface may be generated at the server and accessed via the user device, with the user interface including content directed to collecting the survey content data 304 for the data collection method.

The survey content data 304 is provided by the user via the input device. The survey content data 304 may be provided at the user device and transmitted to the server.

At 412, an electronic survey is generated using the survey content data 304 collected at 408. Generating the survey may include using the survey content data 304 and other data collection method data 382 for the data collection method to build a survey program implementing the data collection method. Generating the survey may include the use of preexisting software modules (e.g. data collection method module 317, concept tester module 319 of FIG. 3) configured to implement specific data collection methods using survey content data 304. For example, a concept tester module 319 may include computer-implemented instructions and data for generating a concept test survey once having received the survey content data 304 from the user. The concept tester module 319 (or other data collection method module, as the case may be) may include reusable instructions and data that can be used to generate surveys for multiple different users (researchers) using the survey content data 304 of those multiple users to make the survey specific to each user.

Optionally, at 416, the survey generated at 412 may be previewed (for example, via survey previewer module 321 of FIG. 3). Previewing the survey allows a researcher to view and navigate the survey from the respondent's perspective and to identify and correct any issues. To the extent that any issues are identified, the issues may be resolved by revising the collected survey content data 304 at 408 or at the survey generation stage at 412. The survey preview is displayed in the user interface at the user device. The survey preview may allow collection of response data 306, for example for the purpose of navigating the survey, but may not store the response data 306 long-term as may be done for response data provided by a respondent.

At 420, the survey is deployed to respondents (for example, via survey deployer module 323). The survey may be a web-based application running on the server that is accessed via a web browser executed on the user device (e.g. respondent device 18 of FIG. 1). In some cases, the respondent may access the survey by logging into a user account associated with the respondent.

At 424, survey response data 306 is collected. The survey response data 306 is provided by the respondent via the input device 305, for example at the respondent device. The response data 306 is transmitted from the respondent device to the server. The response data 306 is stored at the server, for example at memory 302. The response data 306 from multiple respondents can be aggregated and analyzed at the server.

At 428, a survey report is generated using the response data 306. The survey report includes survey report data 384. The survey report reports the results of the survey. Generating the survey report may include analyzing the survey response data 306, such as via the reporting engine 325, to generate insights and create visualizations (e.g. charts, graphs, tables, etc.) of the results. The report may be accessed by the researcher or another permitted user at the user device (e.g. researcher device 16). The display displays the survey report in a user interface at the researcher device.

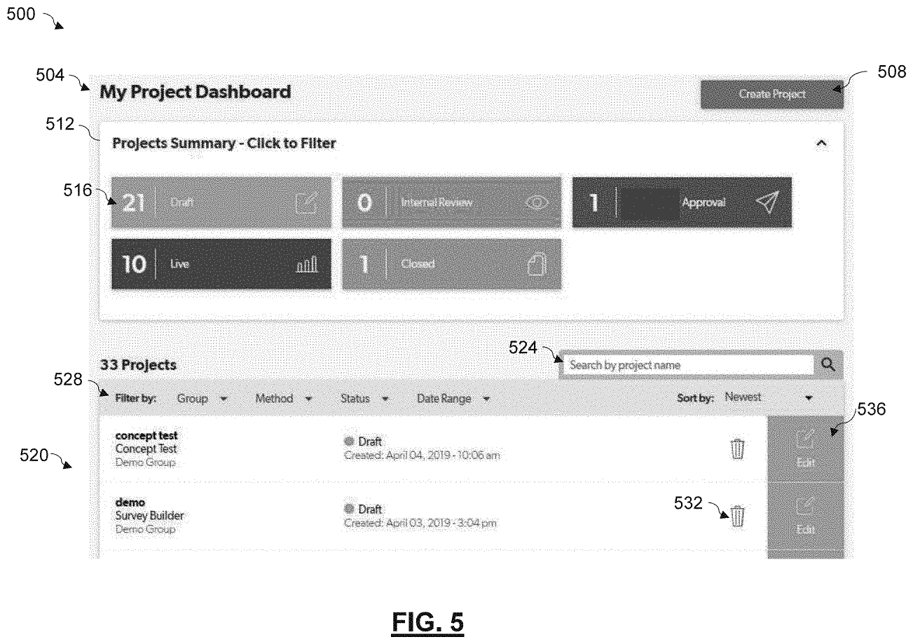

Referring now to FIG. 5, shown therein is a graphical interface 500 according to an embodiment of the system 300. The graphical interface 500 can be used to access a project dashboard 504. A user can use the project dashboard 504 to view survey projects accessible to the user, access a survey project, and create a survey project.

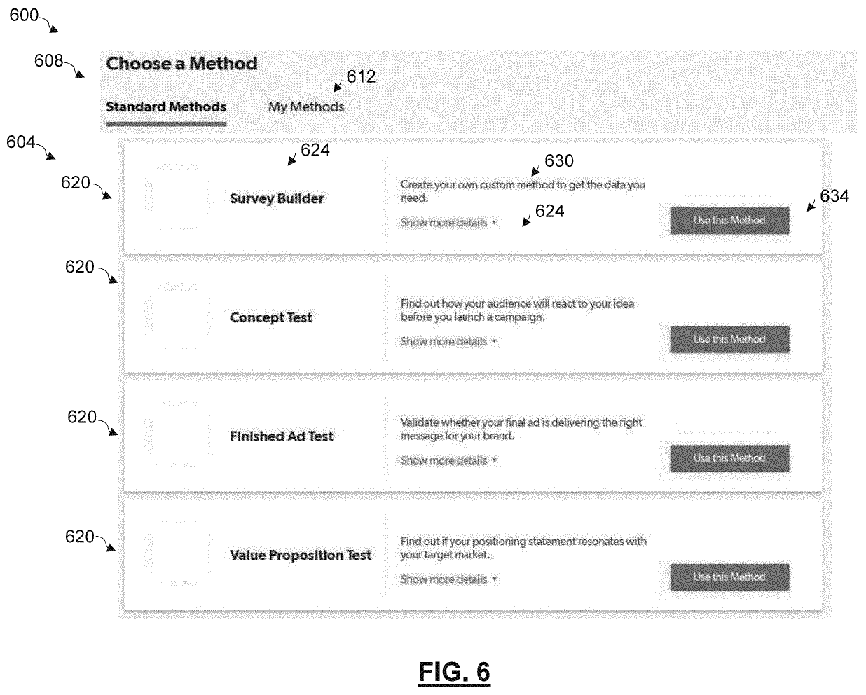

At 508, the user can choose to create a survey project by selecting a create project icon. By choosing to create a survey project, the user may be taken to a second graphical interface that can be used to enter and/or receive a data collection method selection (e.g. graphical interface 600 of FIG. 6).

At 512, the user can view a project summary. The project summary includes a breakdown of projects by status type (e.g. draft, internal review, survey programmer approval, live, closed) and a number of projects for the status type.

At 516, the user can select a draft status type. Selecting the draft status type filters out survey projects other than survey projects at the draft stage. The user can select other status types in the project summary to filter for those status types.

At 520, the user can view a list of projects. In a default mode, the project list may include all projects. The project list may include various data for a project such as a name of the project, a method type for the project, a group type for the project, a status type for the project, and date metadata for the project. The user may access the project by selecting the project in the project list.

At 524, the user can search the project list by entering a project name. Initiating a search at 524 may return search results in the project list 520.

At 528, the user can filter the project list 520 according to any one or more of a group type, a method type, a status type, and a date range. The group type may include a demo group. The method type may includes a data collection method (e.g. concept test). The status type may include draft, user review, reviewer approval, live, or closed.

At 532, the user can delete a project from the project list 520.

At 536, the user can access an editable version of the survey project.

Referring now to FIG. 6, shown therein is a graphical interface 600 according to an embodiment of the system 300. The graphical interface 600 can be used to enter and/or receive a data collection method selection for a project.

The graphical interface 600 includes a list of available data collection methods 604. The list of available data collection methods 604 may include standard methods 608 and custom methods 612. Examples of standard methods 608 include but are not limited to a custom method builder method, a concept test method, a finished ad test method, and a value proposition test method. The standard methods 608 and custom methods 612 may be in different tabs within the interface 600, wherein when one tab is selected and showing (e.g. standard methods), the other tab is hidden (e.g. custom methods).

An available data collection method may be presented as a tab 616 with associated metadata. An available data collection method 620 may include a method name 624, a brief method description 628, and a detailed method description 630. The detailed method description 630 may be hidden from view until selected by the user (e.g. via a hidden tab or pop up window feature).

At 634, the user can enter a data collection method selection for the method 620. Examples of data collection method selections can include but are not limited to a custom method selection, a concept test selection, a finished ad test selection, and a value proposition test selection.

Referring now to FIG. 7, shown therein is a graphical interface 700 according to an embodiment of the system 300. The graphical interface 700 can be used to view an overview of survey content data 304 for a survey project and to enter and/or receive survey content data 304. In particular, the graphical interface can be used to view an overview of survey content data 304 enter and/or receive survey content data 304 for a concept test method. The survey content data 304 can include target audience data, test subject matter data, concept data, video response data, and notes and PO number data. The page may be rendered dynamically based on the configuration settings of the method. In an embodiment, the page is not hard coded and can be modified at any time without the need to deploy.

At 704, the user can view a project name and project method type.

At 708, the user can view target audience data for the project. The target audience data may include a language, a region (e.g. a country), a response number, a quote control (sample type), and a demographic.

At 712, the user can edit the target audience data, which may include entering and/or selecting target audience data.

At 716, the user can view test subject matter data for the project. The test subject matter data may include a product category (e.g. dog food) and a brand name (e.g. Mutte).

At 720, the user can view concept data for the project. The concept data has been previously added to the project by a user (who may or may not be the same user viewing the interface 700).

At 724, the user can select to add video response to the project.

At 728, the user can enter notes and/or PO number data for the project.

At 732, the user can send the project for launch, which may include submitting the survey for internal review and/or survey programmer approval.

At 736, the user can view the survey in a preview mode. The preview mode may display the survey in a popup-type window in the interface 700.

In some variations, the interface 700 may include a track project history function for tracking the history of a survey project. The user may interact with or view the project history by, for example, selecting an icon on the interface 700 representing the track history function. The track history function may allow the user to track various changes to the project over time, such as over multiple sessions, or across multiple users.

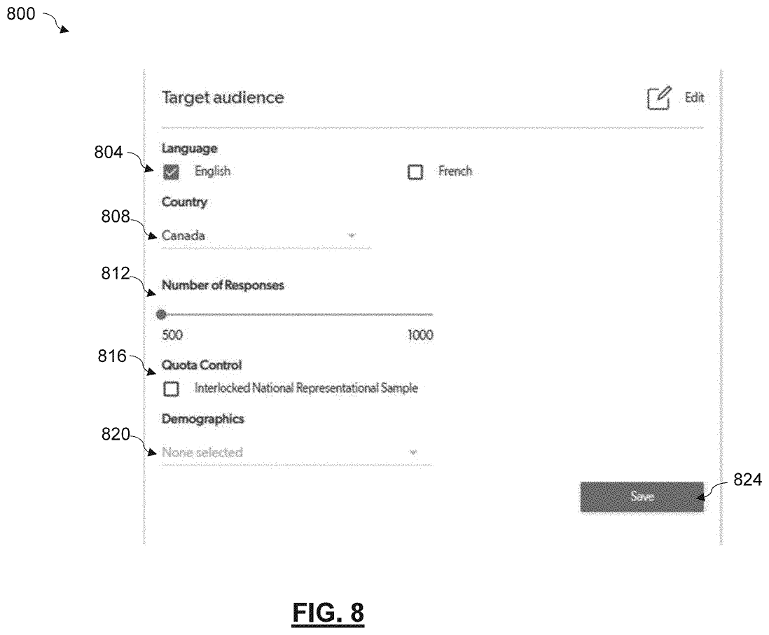

Referring now to FIG. 8, shown therein is a graphical interface 800 according to an embodiment of the system 300. The graphical interface 800 can be used to enter and/or receive target audience data.

At 804, the user can select and/or enter a survey language for the project. Example survey languages may be but are not limited to English and French.

At 808, the user can select and/or enter a survey country for the project. Example survey countries may be but are not limited to the United States and Canada. In variations, the user may select a survey country (or other region) from a drop-down list of available survey countries. In another variation, the user may enter a country name via a text field or the like.

At 812, the user can select and/or enter a response number for the project. The response number includes a number of respondents for the survey. The response number may be selected from a range of response numbers. In variations, the user may enter a response number via a text field or the like. In other variations, the user may use a slider function to set the response number within a range.

At 816, the user may select and/or enter a quota control (or sample type) for the project. The quota control may be selected from a set of predefined sample types. An example sample type may be an interlocked national representative sample.

At 820, the user may select and/or enter a demographic for the project. The demographic may be selected from a set of predefined demographics, such as via a dropdown list.

At 824, the user can save the target audience data. Saving the target audience data may include transmitting the target audience data from the user device (e.g. researcher device 16) to the server 12. The target audience data creates a profile of the audience that the data collection method (e.g. survey) is invited to.

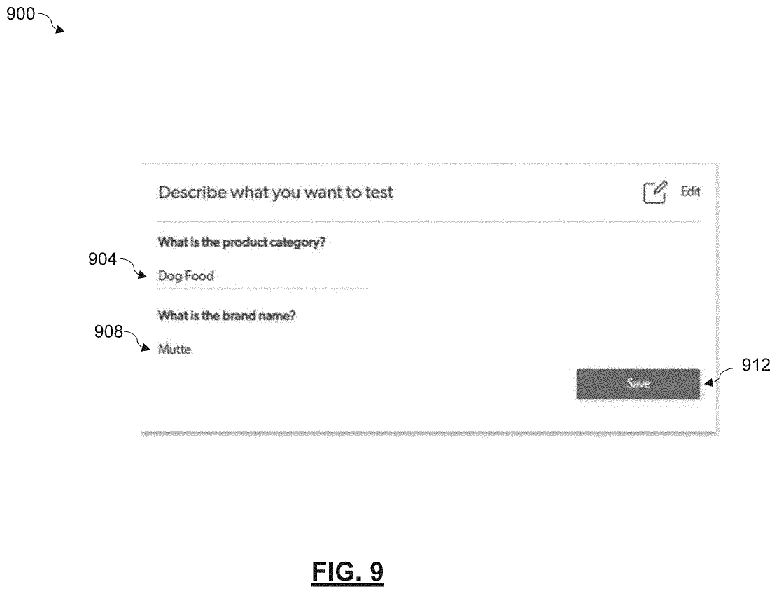

Referring now to FIG. 9, shown therein is a graphical interface 900 according to an embodiment of the system 300. The graphical interface 900 can be used to enter and/or receive test subject matter data. In particular, the test subject matter data may be for a concept test method.

At 904, the user can select and/or enter a product category for the project. An example product category may be “dog food” or “coffee”. The data collection method may be designed to accept any input to support the method. In variations, the product category may be selected from a list of predefined product categories. In other variations, the product category may be entered via a text field or the like.

At 908, the user can select and/or enter a brand name for the project. The brand name may be entered via a text field or the like.

At 912, the user can save the test subject matter data. Saving the test subject matter data may include transmitting the test subject matter data from the user device to the server. The test subject matter data can be stored at the server 12 and used to generate the survey.

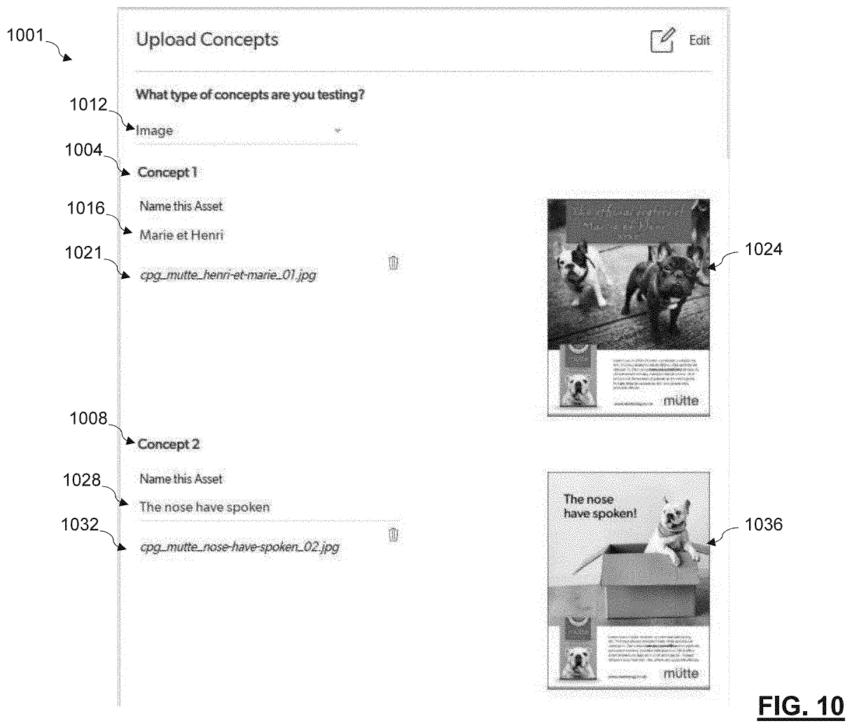

Referring now to FIG. 10, shown therein is a graphical interface 1001 according to an embodiment of the system 300. The graphical interface 1001 can be used to enter and/or receive concept data. The concept data includes concept data for a first concept 1004 and a second concept 1008. In other embodiments, the concept data may include data for any number of concepts.

The concept data includes concept type data 1012.

The concept data for the first concept 1004 includes data for a first concept name 1016 and a first multimedia asset 1021. The first multimedia asset 1021 includes data corresponding to the concept type 1012. The first multimedia asset 1021 may be an image. The graphical interface 1001 includes a previewed first asset 1024.

The concept data for the second concept 1008 includes data for a second concept name 1028 and a second multimedia asset 1032. The second multimedia asset 1032 includes data corresponding to the concept type 1012. The second multimedia asset 1032 may be an image. The graphical interface 1001 includes a previewed second asset 1036.

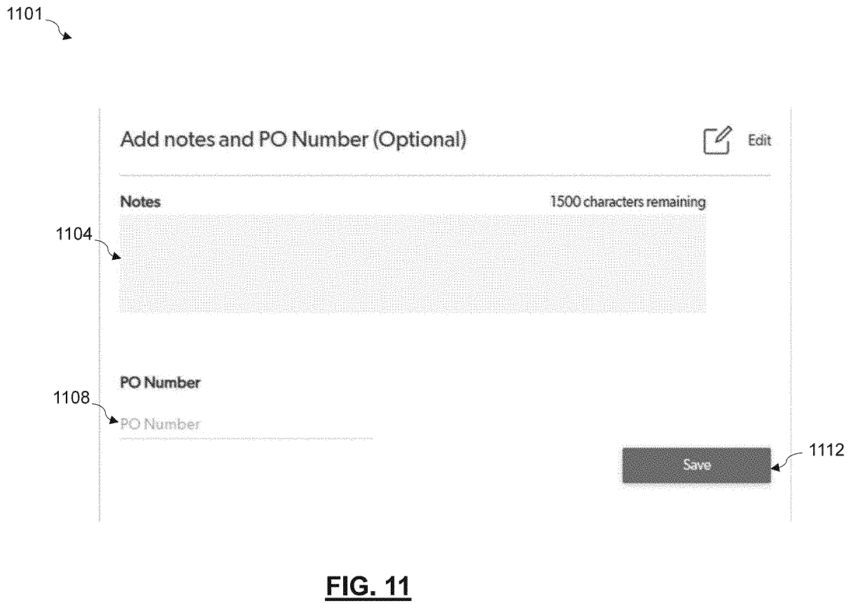

Referring now to FIG. 11, shown therein is a graphical interface 1101 according to an embodiment of the system 300. The graphical interface 11001 can be used to enter and/or receive notes and PO data for the project.

At 1104, the user can enter one or more notes for the project. The notes may be entered into a text field in free text. The text field may have a character limit.

At 1108, the user can enter a PO number for the project. The PO number may be entered via a text field or like.

At 1112, the user can save the note and PO data. Saving the note and PO data may include transmitting the note and PO data from the user device to the server.

In some variations, the interface 1100 may include a track project history function for tracking the history of the project. The user may interact with or view the project history by, for example, selecting an icon on the interface 1100 representing the track history function. The track history function may allow the user to track various changes to the project over time, such as over multiple sessions, or across multiple users.

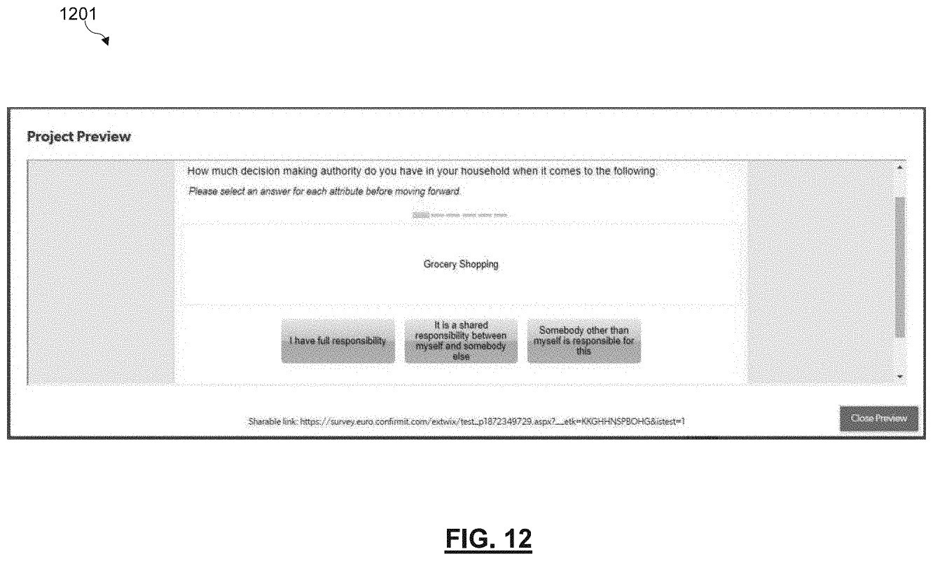

Referring now to FIG. 12, shown therein is a graphical interface 1201 according to an embodiment of the system 300. The graphical interface 1201 can be used to display a survey preview and to enter and/or receive preview response data.

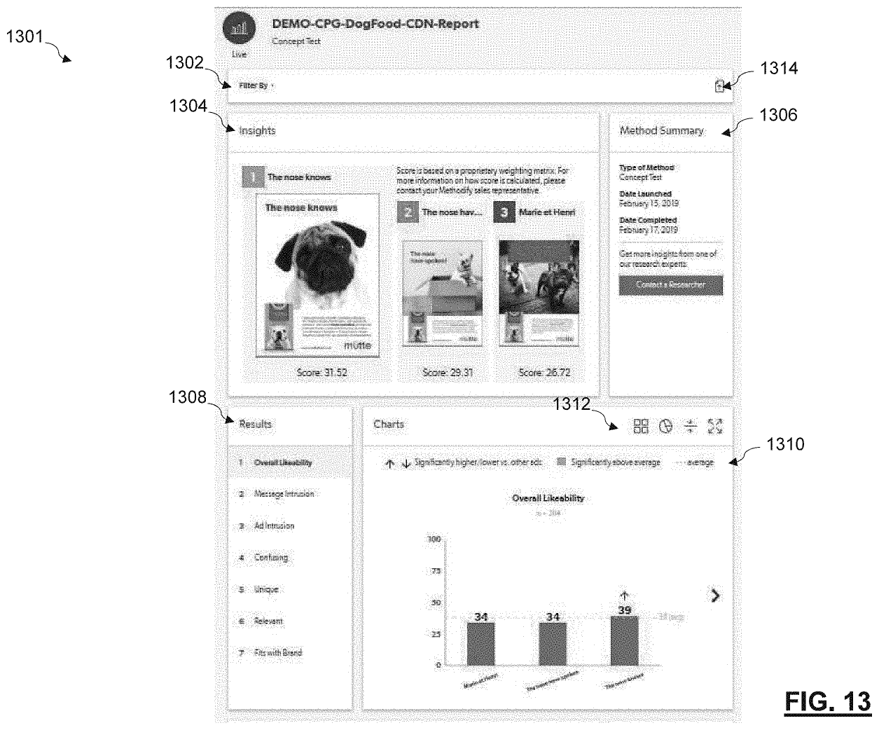

Referring now to FIG. 13, shown therein is a graphical interface 1301 according to an embodiment of the system 300. The graphical interface 1300 can be used to view a survey report. The interface 1301 can also be used to enter and/or receive report preference data. The interface 1301 may display an overview of the survey results. In an embodiment, the report page is rendered dynamically and does not require a deployment to modify the report in any way.

At 1302, the user can select and/or enter report filtering data to filter results presented in the report. The filtering feature may be implemented as a collapsible tab that, when expanded, displays selectable options for filtering. The filtering feature may be implemented by the filtering module 327 of FIG. 3.

At 1304, report insights for the survey are displayed. Report insights may include certain survey content and an associated score and ranking. In an example of a concept test survey, the report insights include image and text description for each tested ad and a ranking and score for each tested ad. The ranking may be determined by the score. The score may be determined using a proprietary weighting matrix.

At 1306, a survey summary is displayed. The survey summary includes survey metadata such as a method type, a launch data, and a completion date.

At 1308, the user can select a results metric. Examples of results metrics include but are not limited to overall likability, message intrusion, ad intrusion, confusing, unique, relevant, fits with brand.

At 1310, a visualization of the selected results metric is displayed. Examples of visualizations include but are not limited to charts, graphs, tables, and the like. At 1312, The user may be able to toggle between different visualizations of the results data, such as between a pie chart and a bar graph.

In some cases, interface 1301 may include interface 1700. In such cases, the interface 1301 also displays demographic results. The demographic results may include a demographic metric selection and a visualization.

At 1314, the user can select an export feature. The export feature may be implemented using the export module 329 of FIG. 3). Exported formats may include PPT, PDF, and Excel. An executive summary may be exported to a PPT or PDF via the export feature. A full report may be exported to a PPT or a PDF via the export feature. Data may be exported to an Excel format via the export feature.

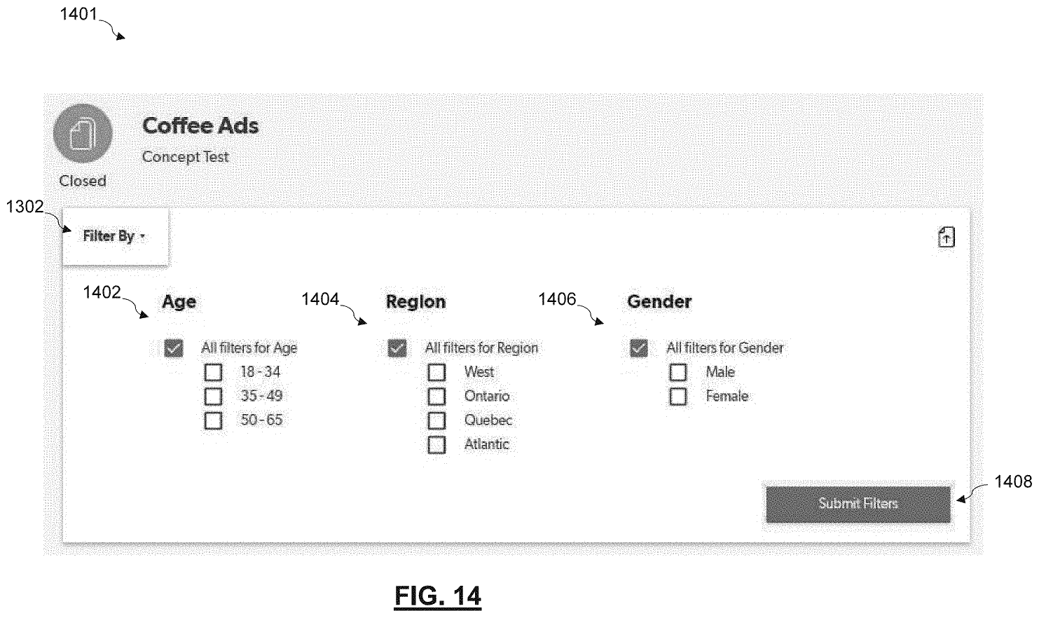

Referring now to FIG. 14, shown therein is a graphical interface 1401 according to an embodiment of the system 300. The graphical interface 1401 can be used to enter and/or receive report filtering data. The filtering data can be selected by the user. The interface 1401 may be the filter tab at 1302 of interface 1300 in an expanded format.

At 1402, the user can select and/or enter age filter data. By doing so, the user can view data by age filter data.

At 1404, the user can select and/or enter geographic filter data. The geographic filter data may include multiple geographic regions. By doing so, the user can view data by geographic filter data.

At 1406, the user can select and/or enter gender data. By doing so, the user can view data by gender data.

The filters may be customized to include any variable required by the user. This may include dynamic configuration without deployment.

At 1408, the user can submit the filter selections. Filtering the report results using one or more of the filters may allow a user to view survey results for a particular demographic (or subset of the total respondents), which may be helpful in deriving insights (e.g. whether an ad is impacting a certain demographic). Additional filters can be added at the request of a user.

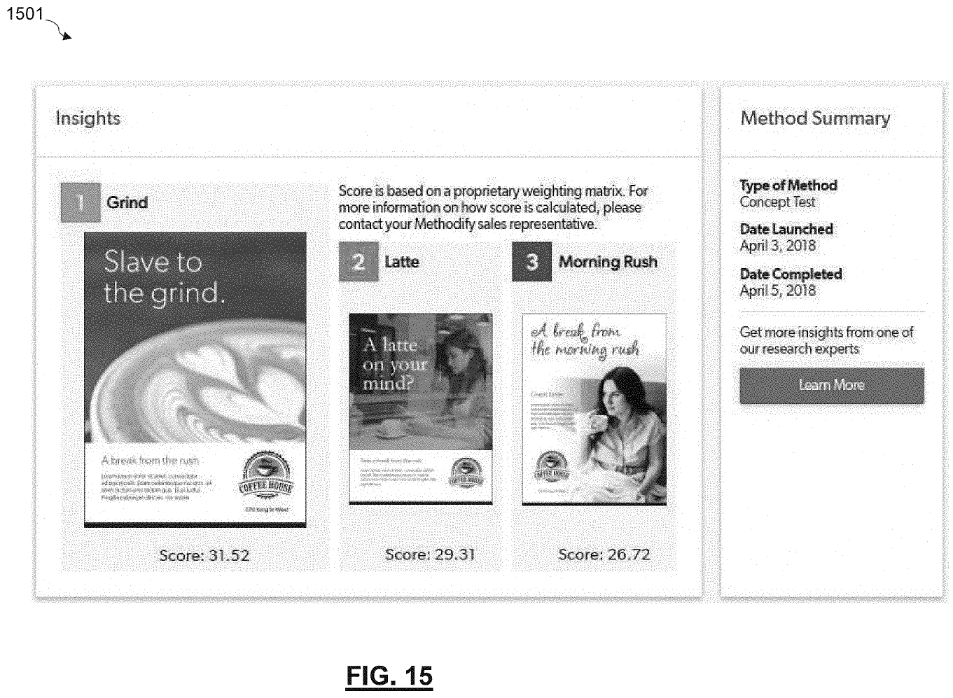

Referring now to FIG. 15, shown therein is a graphical interface 1501 according to an embodiment of the system 300. The interface 1501 can be used to view report insights for the survey. The interface 1501 may be displayed as part of interface 1301. The interface 1501 can be used to view report insights for a concept test survey.

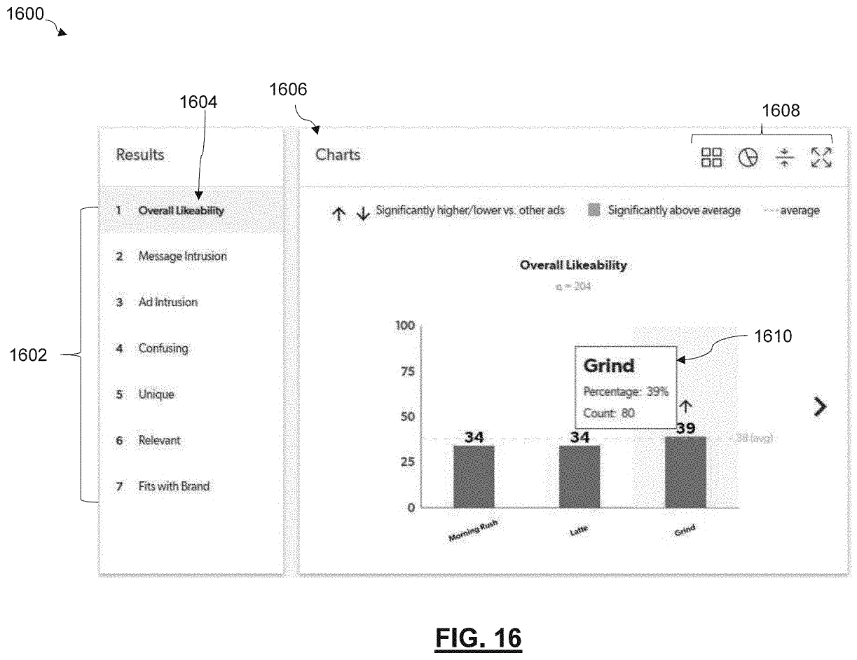

Referring now to FIG. 16, shown therein is a graphical interface 1600 according to an embodiment of the system 300. The interface 1600 can be used to view survey results data 388 according to a metric 1602 (e.g. overall likeability metric 1604). The interface 1600 may be displayed as part of interface 1300. The interface 1600 can be used to view report results data 388 for a concept test survey.

At 1606, a visualization of results data 388 for the selected metric 1604 is displayed. In a particular case, the visualization is a bar graph of results data for the selected metric.

At 1608, the user can toggle between visualizations for the results data 388 (e.g. pie chart, bar graph).

At 1610, a popup modal for a selected tested concept ad is displayed. The popup window includes results data 388 for the concept ad. The popup window may be displayed when a user hovers a cursor over a portion of the visualization corresponding to the concept ad.

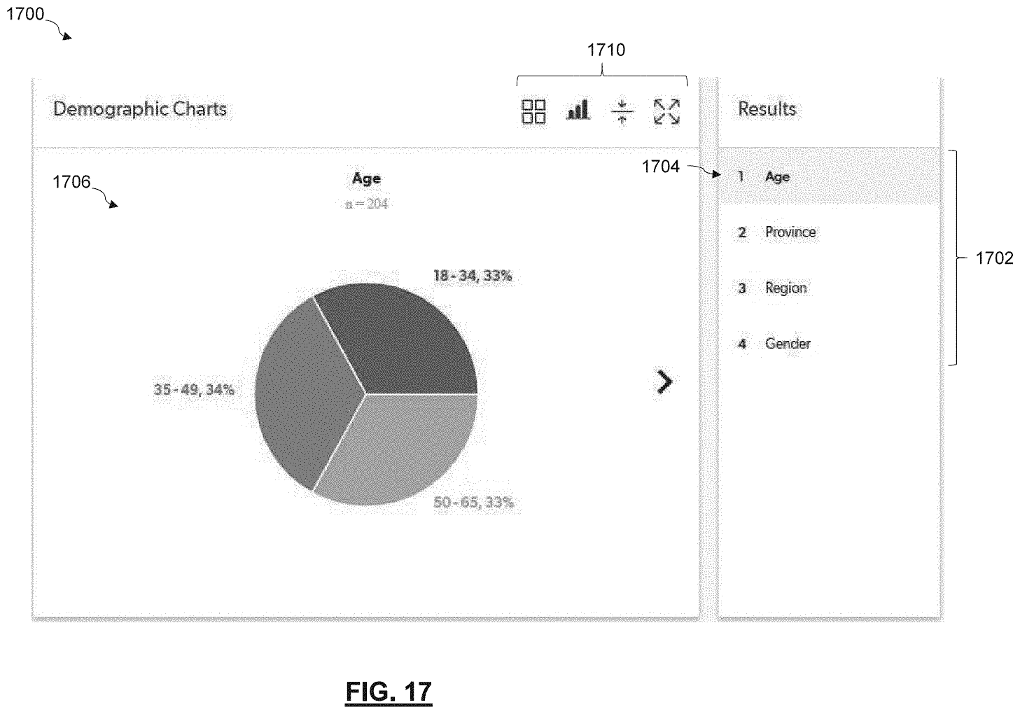

Referring now to FIG. 17, shown therein is a graphical interface 1700 according to an embodiment of the system 300. The interface 1700 can be used to view survey demographic results data 390 according to a demographic selection 1702 (e.g. age demographic 1704, province, region, gender).

At 1706, a visualization of demographic results data 390 for the selected demographic 1704 is displayed. In a particular case, the visualization is a pie chart of demographic results data 390 for the selected demographic.

At 1708, the user can toggle between visualizations for the demographics results data 390 (e.g. pie chart, bar graph).

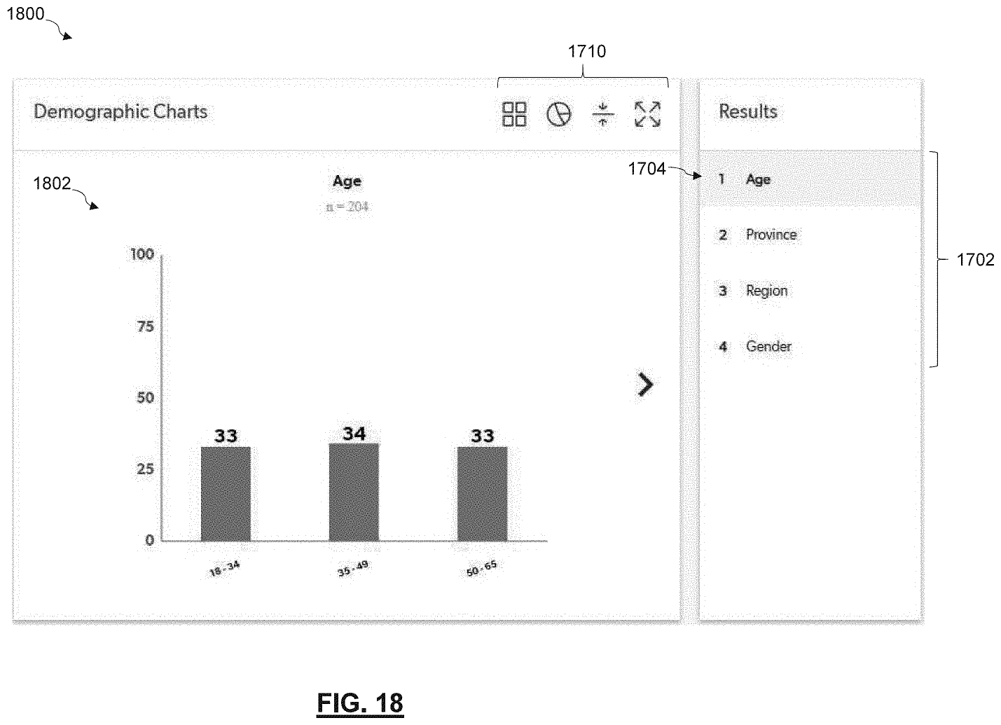

Referring now to FIG. 18, shown therein is a graphical interface 1800 according to an embodiment of the system 300. Interface 1800 illustrates the results data of interface 1700 using a bar graph 1802. The bar graph 1802 can be visualized by toggling the visualization 1710 to bar graph.

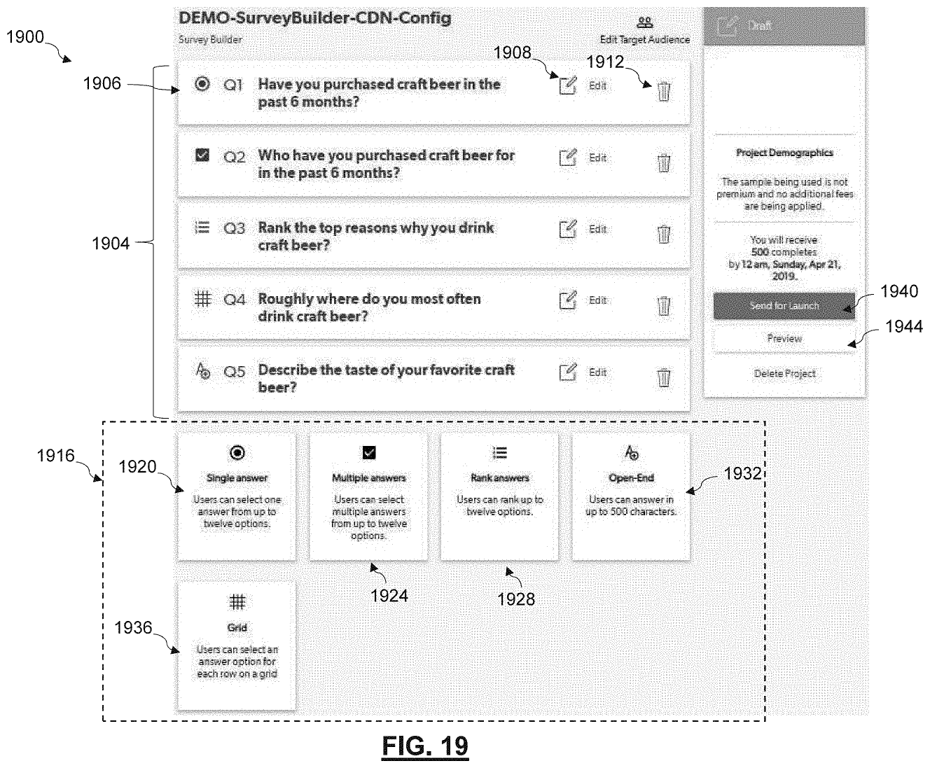

Referring now to FIG. 19, shown therein is a graphical interface 1900 according to an embodiment of the system 300. The graphical interface 1900 can be used to view an overview of survey question data and to enter and/or receive survey content data 304 for a custom survey method.

At 1902, the user can select a survey question type. Example survey question types include a single answer question, a multiple answer question, a rank answers question, an open-end question, and a grid question.

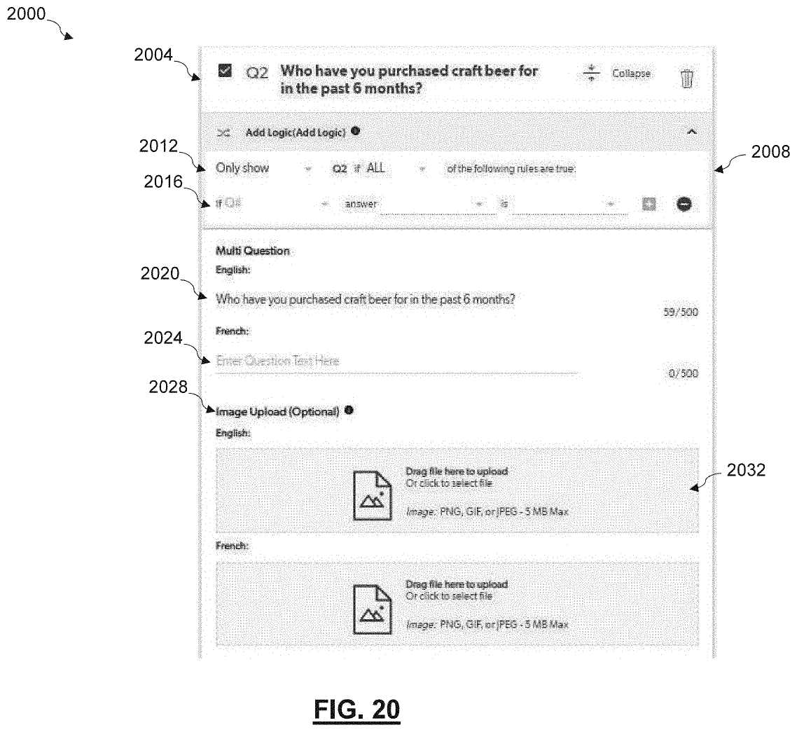

At 1904, the user can view a listing of created survey questions. The listing may include a question text and a question type for the survey question. For example, the list may include a question having the question text “have you purchased craft beer in the past 6 months” and the question type “single answer”. The question listing may provide the user with a convenient overview of the created survey questions. Questions in the question list may be displayed as a question tab 1906. The question tab 1906 may be collapsible such that, when expanded, the question tab display interface 2000 of FIG. 20 (or a portion thereof).

The user may be able to change the order of the questions. For example, the interface 1900 may present a listing of survey questions similar to the listing shown at 1904. The user may be able to manipulate the positioning of the question tab 1906 (and thus the question) in the listing 1904 via user input (e.g. selecting, clicking, dragging). In an embodiment, the interface 1900 may include one or more selectable icons as part of the question tab 1906. The selectable icons may be displayed above and/or below the question identifier or number (e.g. Q1). The selectable icon, when selected, may move the question down in the listing 1904, or up in the listing 1904. A question at the top of the listing 1904 (e.g. Q1) may include a single icon that, when selected, moves the question down in the listing 1904. This is because the top question can only be moved down in the listing 1904. Similarly, a question at the bottom of the listing 1904 (e.g. Q5) may include a single icon that, when selected, moves the question up in the listing 1904. Questions in the listing that are neither the top nor the bottom question in the listing 1904 (e.g. Q2, Q3, Q4) may include multiple selectable icons. For example, a first selectable icon, when selected, moves the question down in the listing 1904, and a second selectable icon, when selected, moves the question up in the listing 1904. Depending on where a question is moved in the listing 1904, the number and/or type of selectable icons for moving the question may change (e.g. a top question moves down in the listing and can now be moved up or down), and the question numbering in the question tab 1906 may change to represent the new position of the moved question in the listing 1904 (and other question tabs 1906 may change as well, depending on the move). In other embodiments, question tab 1906 may be moved within the listing 1904 in any other suitable manner, such as dragging the question tab 1906 into a new position in the listing 1904 or entering (e.g. via typing in a number) or selecting a new number or position in the listing 1904 for the question tab 1906.

At 1908, the user can select an edit function for a survey question to edit the survey question data. By selecting the edit function, the tab for the survey question may expand to show survey question data for the survey question in an editable format.

At 1912, the user can delete the survey question from the survey.

At 1916, the user can select a question type to add to the survey (and question list). The user may select a question type from a dropdown list of available survey question types or an icon representing an available question type.

At 1920, the user can select a single answer question to add to the survey.

At 1924, the user can select a multiple answer question to add to the survey.

At 1928, the user can select a rank answers question to add to the survey.

At 1932, the user can select an open-end answer question to add to the survey.

At 1936, the user can select a grid answer question to add to the survey.

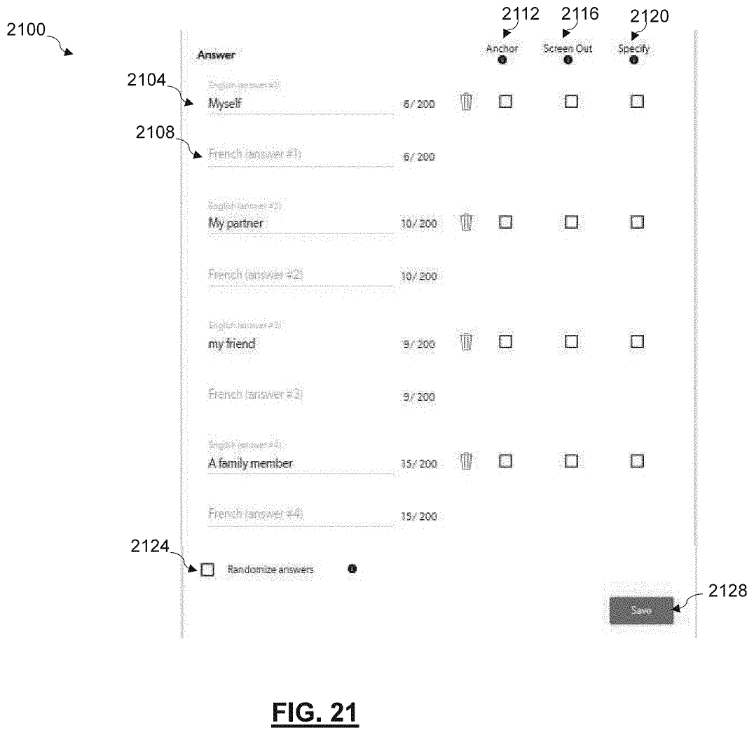

By selecting any one of the foregoing question types 1920, 1924, 1928, 1932, a new question tab can be added to the question list 1904. The user can select the question in the question list 1904 to enter survey question data. Selecting the question type at 1916 may generate a second graphical interface (e.g. interfaces 2000, 2100 of FIGS. 20, 21 respectively). for a user to select and/or enter survey question data for the new survey question.

At 1940, the user can send the project for launch. Sending the project for launch may include making the survey available for internal review or survey programmer approval.

At 1944, the user can select a preview mode. By selecting the preview mode, a preview for the project can be displayed as the respondent will experience it (e.g. at the display of the user device 16).

Referring now to FIG. 20, shown therein is a graphical interface 2000 according to an embodiment of the system 300. The graphical interface 2000 can be used to enter and/or receive logic data and multi-answer question data for a project. The logic data and multi-answer question data can be used to generate a survey for the project. The interface 2000 may be used for a custom survey method. In an embodiment, the interface 2000 may be provided together with the graphical interface 2100 (described below) as a single graphical interface (for example, at user device 16) for entering and/or receiving survey question data.

The interface 2000 includes a question tab 2004. The question tab 2004 may be a collapsible tab in an expanded format. The question tab 2004 may be a question tab 1906 in the question list 1904. In some variations, the question tab 2004 may be a question tab 1906 in an expanded format from the survey question list 1904 of interface 1900.

At 2008, the user can select and/or enter logic data for the survey question. The logic data may include a logic statement. The logic statement may include a master statement 2012 and one or more sub-statements 2016. Example master statements may include but are not limited to “only show [question number] if all of the following are true” and “don't show [question number] if any of the following are true”. Example sub-statements may include but are not limited to “if [question number] answer [answer option] is selected” and “if [question number] answer [answer option] is not selected”. In an embodiment, the user can complete the master statement 2012 and sub-statement(s) by selecting among available options, for example via a dropdown list or the like.

At 2020, the user can enter question text data for the survey question. The question text data can be provided for a first survey language. The user may enter the question text data into a text field or the like. Example question text data may be “who have you purchased craft beer for in the past 6 months?”. At 2024, the user may enter question text data for a second survey language.

At 2028, the user can select and/or enter image data for the question. In variations, the image data may be entered by a drag-and-drop operation of an image file into a target location 2032 and/or by selecting an image file using a browse operation or the like. Entering the image data may transmit the image data from the user device 16 (or other location) to the server 12.

Referring now to FIG. 21, shown therein is a graphical interface 2100 according to an embodiment of the system 300. The graphical interface 2100 can be used to enter and/or receive multi-answer question data. As described above, the interface 2100 may be presented together with interface 2000 of FIG. 20 as a single graphical interface for entering and/or receiving survey content data 304.

In particular, the interface 2100 can be used to enter and/or receive answer option data for the survey question.

At 2104, the user can enter a select and/or enter an answer option. The answer option may be entered as text into a text field or the like. At 2108, the user can select and/or enter the answer option in a second survey language.

At 2112, the user can select an anchor feature for the answer option. The anchor feature, when selected, keeps the “anchored” answer option in its current position in the answer option listing, regardless of any randomization.

At 2116, the user can select a screen out feature for the answer option. The screen out feature, when selected, may allow a respondent to view one or more additional questions if the answer option is chosen by a respondent.

At 2120, the user can select a specify feature for the answer option. The specify feature, when selected, may prompt a respondent to provide further explanation for the answer, such as by providing an open-ended answer via a text field or the like.

At 2124, the user can select a randomize feature for the answer options. The randomize feature, when selected, may cause non-anchored answer options to be presented in a randomized order to the respondent.

At 2128, the user can save the survey question data. Saving the survey question data may include transmitting the survey question data from the user device 16 to the server 12. The survey question data may be stored at the server 12 and used to generate a survey.

While the above description provides examples of one or more apparatus, methods, or systems, it will be appreciated that other apparatus, methods, or systems may be within the scope of the claims as interpreted by one of skill in the art.

1. A system for automated market research, the system comprising:
a market research automation server, the server including a processor configured to:
receive survey content data from a researcher device;
generate a survey program from the survey content data, the survey program for provisioning an electronic survey, the survey program including a data collection method;
receive survey response data from a respondent device;
generate a survey report from the response data;
transmit the survey report to a respondent device;
a researcher computing device communicatively connected to the research automation server via a network, the researcher computing device configured to transmit the survey content data to the research automation server; and
a survey respondent computing device communicatively connected to the research automation server via the network, the survey respondent computing device configured to receive the survey report from the research automation server and display the survey report.

2. The system of claim 1, wherein the data collection method includes a concept tester method including determining how an audience may react to a researcher concept prior to launching a campaign.

3. The system of claim 1, wherein the data collection method includes a finished ad tester method including validating whether a final ad is delivering an appropriate message and impact for a brand.

4. The system of claim 1, wherein the data collection method includes a value proposition tester method including determining if a positioning statement resonates with a brand target market

5. The system of claim 1, wherein the data collection method includes a digital experience validation method including determining how an audience will react to a certain digital experience.

6. The system of claim 1, wherein the data collection method includes a user experience testing method including determining the ease with which an audience can successfully complete pre-assigned tasks.

7. The system of claim 1, wherein the data collection method includes an ad tracker method including optimizing a brand's creative and media investments with in-market customer feedback and normative targets across key success benchmarks.

8. The system of claim 1, wherein the data collection method includes an in-store POS method including determining if the researcher is effectively engaging customers along the path to purchase

9. The system of claim 1, wherein the survey content data includes concept data, wherein the concept data includes multimedia data and a text description, wherein the text description provides description for the multimedia, and wherein the multimedia data includes image data or video data.

10. The system of claim 1, wherein the survey content data includes value proposition data, and wherein the value proposition data includes data for a value proposition name and text stimuli.

11. The system of claim 1, wherein the survey content data includes target audience data, and wherein the target audience data includes any one or more of a survey language, an audience region, a response number, a quota control, and a demographic.

12. The system of claim 1, wherein the survey content data includes question text data, and wherein the question text data includes question text for any one or more of a single answer question, a multi-answer question, a rank answers question, an open-end question, and a grid question.

13. The system of claim 1, wherein the survey content data includes image data and an image as part of the survey question, wherein the survey question is about the image itself, and wherein the image includes an advertisement.

14. The system of claim 1, wherein the survey content data includes answer data, and wherein the answer data includes data for answer options for a survey question.

15. The system of claim 1, wherein the survey content data includes answer presentation data, wherein the answer presentation data informs how answer options may be presented to the respondent in the survey, and wherein the answer presentation data includes any one or more of anchoring an answer option, screening out an answer option, specifying an answer option, and randomizing answer options.

16. The system of claim 1, wherein the survey content data includes logic data, wherein the logic data includes a question where selection of a particular answer option drives the ability of the respondent to see the next question, wherein the logic data includes a logic statement, and wherein the logic data corresponds to the logic statement.

17. A market research automation server for use in an automated research system, the research automation server configured to:
receive survey content data from a researcher device, the researcher device communicatively connected to the research automation server via a network;
generate a survey program from the survey content data, the survey program for provisioning an electronic survey, the survey program including a data collection method;
receive survey response data from a respondent device, the respondent device communicatively connected to the research automation server via the network; and
generate a survey report from the survey response data.

18. The method of claim 17, wherein the survey program includes a data collection method, and wherein the data collection method is determined according to a data collection method selection received by the research automation server.

19. A method of performing automated market research, the method comprising:
receiving survey content data from a researcher;
generating a survey program from the survey content data, the survey program configured to provision an electronic survey, the survey program including a data collection method;
receiving survey response data; and
generating a survey report from the response data.

20. The method of claim 19, wherein the survey content data includes a data collection method selection, and wherein the data collection method selection determines the data collection method included in the survey program.
